(19) United States
(12) Patent Application Publication
(10) Pub. No.: US 2024/0322380 A1
(43) Pub. Date: Sep. 26, 2024

(54) BATTERY PACK

(71) Applicant: Samsung SDI Co., Ltd., Yongin-si (KR)

(72) Inventors: Mansik Cho, Yongin-si (KR); Youngbin Ko, Yongin-si (KR); Kwangsoo Bae, Yongin-si (KR)

(21) Appl. No.: 18/606,303

(22) Filed: Mar. 15, 2024

(30) Foreign Application Priority Data
Mar. 26, 2023 (KR) 10-2023-0039388

(51) Int. Cl. H01M 50/503; H01M 50/244; H01M 50/507

(52) U.S. Cl. CPC H01M 50/503; H01M 50/244; H01M 50/507

(57) ABSTRACT

A battery pack includes a cell holder to which a plurality of battery cells are assembled and a bus bar assembly including a bus bar electrically connecting the plurality of battery cells to each other, and a protrusion protruding from the bus bar to at least a portion of a thickness of the cell holder. The plurality of battery cells are arranged on a first side of the cell holder, and the bus bar assembly is located on a second side of the cell holder opposite the first side of the cell holder. The cell holder integrated with the bus bars, which are firmly fixed at appropriate positions on the cell holder, may be provided through insert injection molding.

### CROSS-REFERENCE TO RELATED APPLICATION

The present application claims priority to and the benefit of Korean Patent Application No. 10-2023-0039388, filed on Mar. 26, 2023 in the Korean Intellectual Property Office, the entire disclosure of which is incorporated herein by reference.

### BACKGROUND

### 1. Field

Aspects of one or more embodiments relate to a battery pack.

### 2. Description of the Related Art

In general, secondary batteries can be charged and discharged, unlike primary batteries that cannot be charged. Secondary batteries are used as energy sources for mobile devices, electric vehicles, hybrid vehicles, electric bicycles, uninterruptible power supplies, etc. Also, depending on the type of external devices to which secondary batteries are applied, the secondary batteries may be used in the form of a single battery or a module in which a plurality of batteries are connected and bundled into a unit.

A small mobile device, such as a mobile phone, may operate for a certain period of time with only the output and capacity of a single battery. However, when use for a long period of time and high power are required, such as in an electric vehicle or a hybrid vehicle that consumes a lot of power, a module type including a plurality of batteries may be used due to the output and capacity thereof. Also, the output voltage or output current may be increased according to the number of batteries embedded or included therein.

### SUMMARY

According to an aspect of one or more embodiments, a battery pack includes bus bars that electrically connect a plurality of battery cells to each other and have protrusions for fixing positions of the bus bars. Therefore, a cell holder integrally formed with the bus bars may be installed using fixing jigs that come into contact with and press the protrusions, and a bus bar-integrated cell holder may be installed in which the bus bars are firmly fixed to the cell holder at appropriate positions.

Additional aspects will be set forth, in part, in the description which follows and, in part, will be apparent from the description, or may be learned by practice of the presented embodiments of the present disclosure.

According to one or more embodiments, a battery pack includes a cell holder to which a plurality of battery cells are assembled; and a bus bar assembly including a bus bar electrically connecting the plurality of battery cells to each other, and a protrusion protruding from the bus bar to at least a portion of a thickness of the cell holder, wherein the plurality of battery cells is arranged on a first side of the cell holder, and the bus bar assembly is located on a second side of the cell holder opposite the first side of the cell holder.

In one or more embodiments, the plurality of battery cells may be arranged on the first side of the cell holder, and the protrusion may protrude from the bus bar located on the second side of the cell holder to at least a portion of the thickness of the cell holder.

In one or more embodiments, the protrusion may pass through the cell holder and may be exposed via a lower surface of the cell holder opposite the bus bar.

In one or more embodiments, the bus bar may include a first surface facing the cell holder and a second surface opposite the cell holder, and the protrusion may include a first protrusion protruding from the first surface toward the cell holder by a depth, and a second protrusion protruding from the second surface by a height on the opposite side to the cell holder.

In one or more embodiments, the depth of the first protrusion may be the same (same or substantially same) as the height of the second protrusion.

In one or more embodiments, the first and second protrusions may be located at positions of the bus bar facing each other.

In one or more embodiments, the first and second protrusions may be respectively arranged on a first side and a second side, which are opposite to each other, of a protrusion member arranged at positions spaced apart from each other along a length of the bus bar.

In one or more embodiments, the plurality of battery cells may be configured such that a column of battery cells is arranged in a column direction and a plurality of columns of battery cells are arranged in a row direction crossing the column direction, and the battery cells in columns adjacent to each other in the row direction are alternately arranged with each other at front and rear positions in the column direction.

In one or more embodiments, the bus bar may be provided in plural to electrically connect the plurality of battery cells to each other, and the plural bus bars may be adjacent to each other in the column direction and each of the bus bars may extend between a first group of battery cells arranged in the row direction and a second group of battery cells arranged in the row direction.

In one or more embodiments, each of the first and second groups of battery cells may include battery cells in odd-numbered columns and battery cells in even-numbered columns which are alternately arranged in the row direction.

In one or more embodiments, each of the plurality of bus bars may extend in a zigzag pattern while forming curved sections around outer circumferential surfaces of electrodes respectively formed at central positions of the first and second groups of battery cells.

In one or more embodiments, the curved sections may surround outer circumferential surfaces of first electrodes respectively formed at central positions of the first and second groups of battery cells or may surround outer circumferential surfaces of first electrode holes respectively formed in the cell holder to expose the first electrodes.

In one or more embodiments, the curved sections adjacent to each other along a length of the bus bar may surround an outer circumferential surface of a first electrode at a rear position and an outer circumferential surface of a first electrode at a front position, which are opposite to each other in the column direction, among the outer circumferential surfaces of the first electrodes of the first and second groups of battery cells.

In one or more embodiments, the protrusion may be formed in each of the curved sections of the bus bar.

In one or more embodiments, the protrusion may be provided in pairs formed in the curved sections that face each other and surround the electrode of each of the plurality of battery cells.

In one or more embodiments, first and second electrodes arranged at a first end of each of the battery cells may be exposed to an outside of the cell holder through first and second electrode holes formed in the cell holder, and the first and second electrodes may be connected to the bus bar, and the second electrode may be arranged at a second end of the battery cell, from among the first and second electrodes.

In one or more embodiments, the first and second electrode holes may be formed at a central position of the first end of the battery cell and a peripheral position thereof around the central position, respectively.

In one or more embodiments, the cell holder may include assembling ribs to surround outer circumferential surfaces of the battery cells and guide assembling positions of the battery cells, and the second electrode hole may be formed between the first electrode hole and the assembling rib in a radial direction of the battery cell from the central position to the peripheral position of the battery cell.

In one or more embodiments, each of the protrusions may be formed together with the second electrode hole between the first electrode hole and the assembling rib.

In one or more embodiments, the protrusion may be formed at first and second angular positions that face each other with the first electrode hole therebetween, and the second electrode hole may be formed at a third angular position that equally divides an angle between the first and second angular positions.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is an exploded perspective view of a battery pack according to one or more embodiments of the present disclosure;

FIG. 2 is a perspective view of a bus bar assembly of the battery pack of FIG. 1;

FIG. 3 is a view showing an upper surface of a cell holder on which the bus bar assembly of FIG. 2 is arranged;

FIG. 4 is an enlarged view showing a region of FIG. 3;

FIG. 5 is a view showing a lower surface of a cell holder of FIG. 1;

FIG. 6 is a perspective view showing a state in which battery cells are assembled to the cell holder of FIG. 5; and

FIG. 7 is a perspective view schematically showing that first and second fixing jigs come into contact with and press first and second protrusions of the bus bar assembly in secondary insert injection molding for integrally forming the bus bar assembly and the cell holder of FIG. 2.

### DETAILED DESCRIPTION

Reference will now be made in further detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

If a portion is referred to as “includes” a component, the portion may not exclude another component but may further include another component unless stated otherwise. More specifically, it is to be understood that the terms “comprise,” “include,” “have,” or the like used herein indicate the presence of features, numbers, steps, operations, components, parts, or a combination thereof described in the specification, and do not preclude the presence or addition of one or more other features, numbers, steps, operations, components, parts, or a combination thereof.

Singular forms include plural forms unless indicated otherwise contextually. In addition, the shapes and sizes of components in the drawings may be exaggerated for clarity of description.

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

Herein, a battery pack according to embodiments of the present disclosure is described with reference to the accompanying drawings.

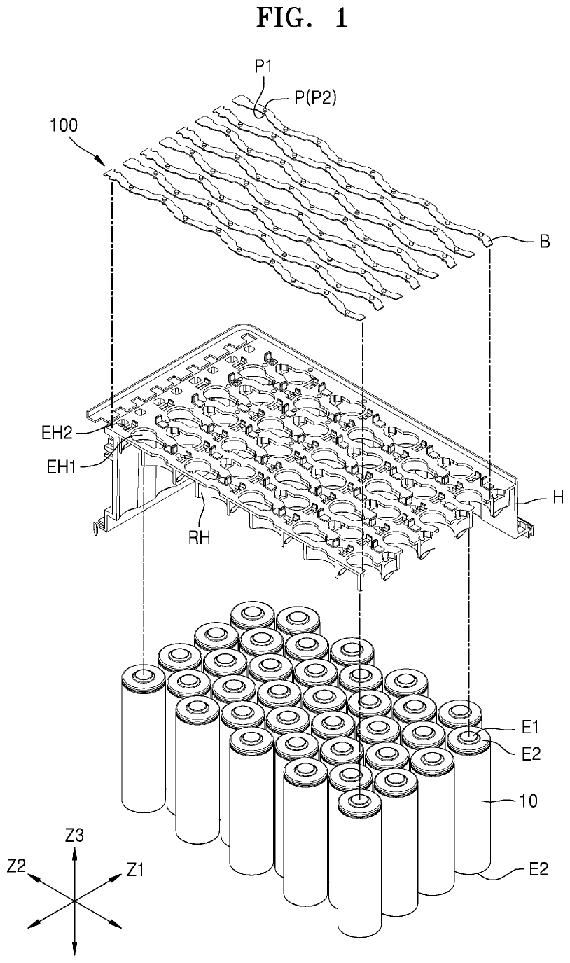

FIG. 1 is an exploded perspective view of a battery pack according to one or more embodiments of the present disclosure.

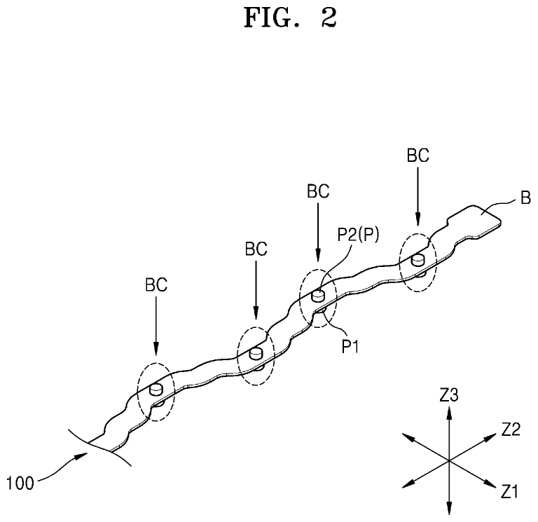

FIG. 2 is a perspective view of a bus bar assembly 100 as a component of the battery pack of FIG. 1.

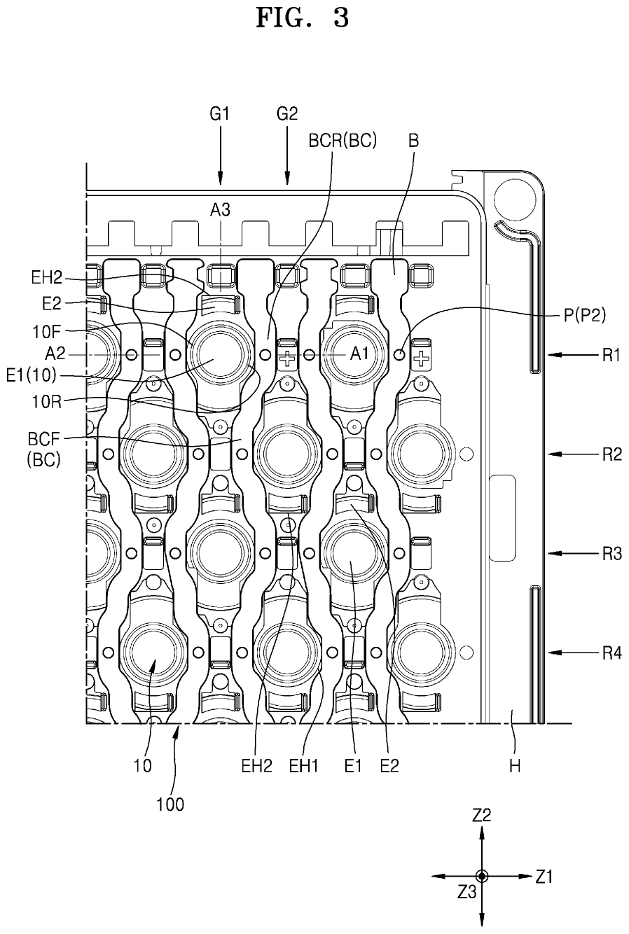

FIG. 3 is a view showing an upper surface of a cell holder H on which the bus bar assembly 100 of FIG. 2 is disposed.

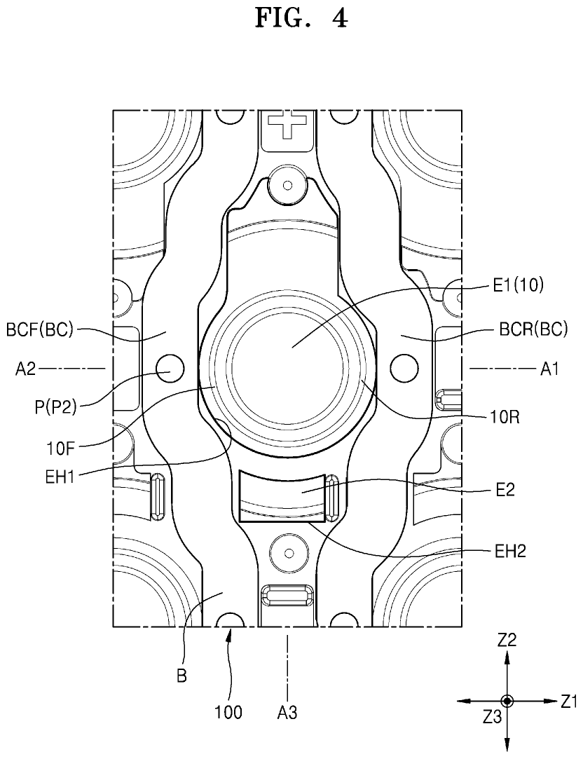

FIG. 4 is an enlarged view showing a region of FIG. 3.

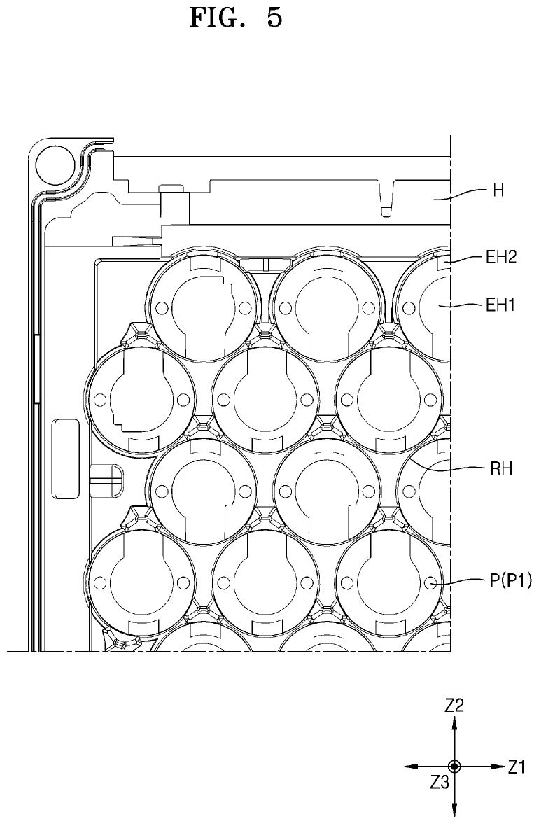

FIG. 5 is a view showing a lower surface of the cell holder H of FIG. 1.

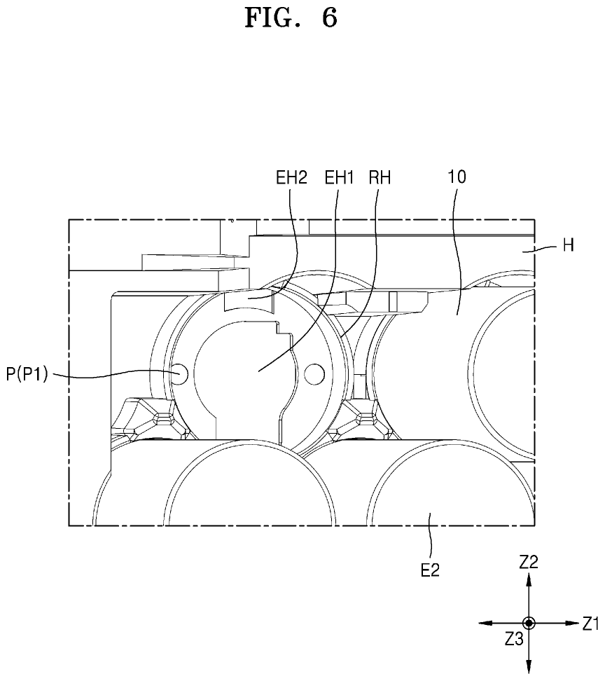

FIG. 6 is a perspective view showing a state in which battery cells 10 are assembled to the cell holder H of FIG. 5.

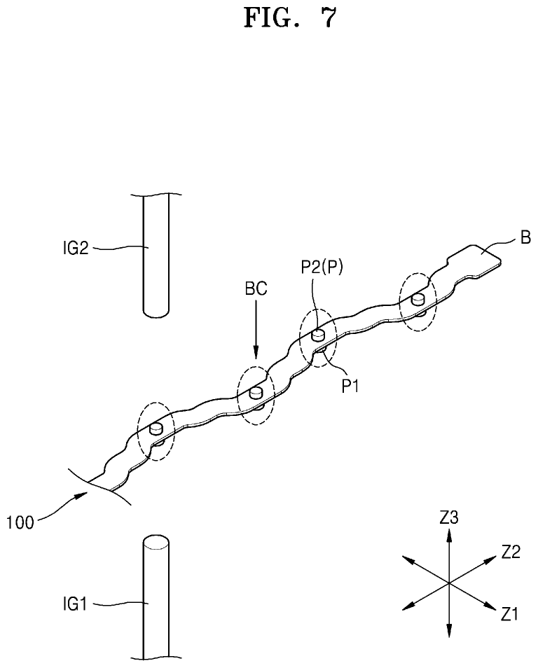

FIG. 7 is a perspective view schematically showing that first and second fixing jigs IG1 and IG2 come into contact with and press first and second protrusions P1 and P2 of the bus bar assembly 100 in secondary insert injection molding for integrally forming the bus bar assembly 100 and the cell holder H of FIG. 2.

Referring to FIGS. 1 to 7, the battery pack according to one or more embodiments of the present disclosure may include the cell holder H for structurally binding the plurality of battery cells 10 to each other and the bus bar assembly 100 for electrically connecting the plurality of battery cells 10 to each other which have been physically bound by the cell holder H. The cell holder H may provide accommodation spaces for the plurality of battery cells 10, and the plurality of battery cells 10 may be physically bound with each other and modularized into a single pack shape. The bus bar assembly 100 may include a bus bar B electrically connecting different battery cells 10 and the first and second protrusions P1 and P2 protruding from the bus bar B.

In embodiments of the present disclosure, the modularization of the plurality of battery cells 10 into a single pack shape may indicate that the plurality of battery cells 10 are structurally bound with each other together with the cell holder H to structurally bind the plurality of battery cells 10 into a single pack shape. Also, as described below, this modularization may indicate that different battery cells 10 are electrically connected to each other to electrically bind the plurality of battery cells 10 into the single pack shape.

For example, the cell holder H may structurally bind the plurality of battery cells 10 to modularize the plurality of battery cells 10 into a pack shape and may regulate assembling positions of the plurality of battery cells 10. The cell holder H may include at least one cell holder H to which a first end and/or a second end of each of the battery cells 10 is assembled. Although not shown in the drawings, according to various embodiments of the present disclosure, the cell holder H may include first and second holders (not shown) assembled facing each other with the plurality of battery cells 10 therebetween, and the plurality of battery cells 10 may be assembled at regulated positions of the first and second holders (not shown). In embodiments of the present disclosure, the cell holder H has the plurality of battery cells 10 arranged on a first side and bus bars B arranged on a second side and electrically connecting the plurality of battery cells 10 to each other. As described above, the cell holder H, which has the plurality of battery cells 10 arranged on the first side and the bus bars B electrically connecting the plurality of battery cells 10 or the bus bar assembly 100 including the battery cells 10 on the second side, may correspond to an insulating structure. For example, throughout this specification, the insulating structure may be configured to form at least a portion of the cell holder H. For example, the insulating structure may correspond to the cell holder H which has the battery cells 10 arranged on the first side and the bus bars B or the bus bar assembly 100 arranged on the second side. In various embodiments of the present disclosure, the insulating structure may form all or part of the cell holder H. In embodiments of the present disclosure, the insulating structure and the cell holder H may be substantially the same component. Herein, for convenience of understanding, this component may be referred to as the cell holder H rather than the insulating structure; however, the insulating structure may form all or part of the cell holder H.

In embodiments of the present disclosure, the bus bar assembly 100 may include the bus bar B for electrically connecting different battery cells 10, and the protrusions P1 and P2 protruding from the bus bar B. For example, the protrusions P1 and P2 may include first and second protrusions P1 and P2 that protrude, in a third direction Z3 corresponding to a height direction, from first and second surfaces of the bus bar B, respectively, which are opposite to each other. In further detail, the bus bar B may include a first surface facing the cell holder H and a second surface opposite the first surface. The bus bar assembly 100 may include a first protrusion P1 protruding to a certain depth from the first surface of the bus bar B toward the cell holder H and a second protrusion P2 protruding from the second surface opposite the first surface of the bus bar B toward the opposite side of the cell holder H to a certain height. In embodiments of the present disclosure, the first and second protrusions P1 and P2 may be formed at positions of the bus bar B facing each other. Throughout this specification, the third direction Z3 may refer to a direction that crosses first and second directions Z1 and Z2 respectively corresponding to a column direction (Z1 direction) and a row direction (Z2 direction) in which the plurality of battery cells 10 are arranged. For example, the third direction Z3 may refer to a direction in which the bus bar assembly 100 and the cell holder H are arranged.

In embodiments of the present disclosure, the first and second protrusions P1 and P2 may be respectively formed as a first side and a second side, opposite to each other, of a protrusion member P that is formed on the bus bar B so as to pass through the bus bar B. For example, in the protrusion member P passing through the bus bar B, a portion protruding from the first surface of the bus bar B toward the cell holder H by a certain depth may form the first protrusion P1 of the bus bar assembly 100. Also, in the protrusion member P passing through the bus bar B, a portion protruding from the second surface of the bus bar B toward the opposite side of the cell holder H by a certain height may form the second protrusion P2 of the bus bar assembly 100. In embodiments of the present disclosure, the bus bar assembly 100 may include the bus bar B and the protrusion member P formed on the bus bar B, and the protrusion member P may be provided in plural (or as a plurality) formed spaced apart from each other along the length of the bus bar B. For example, in embodiments of the present disclosure, rather than extending linearly in one direction (e.g., the second direction Z2), the protrusion members P may be formed spaced apart from each other along the length of the bus bar B that extends in a zigzag pattern to avoid first electrodes E1 of the battery cells 10.

In embodiments of the present disclosure, the plurality of battery cells 10 assembled to the cell holder H may be configured such that a column of battery cells 10 are arranged in a column direction Z1 and a plurality of columns R1, R2, R3, and R4 of the battery cells 10 are arranged in a row direction Z2 crossing the column direction Z1, and the battery cells 10 in columns adjacent to each other in the row direction Z2 are alternately arranged with each other at front or rear positions in the column direction Z1. According to the arrangement of the battery cells 10, among the battery cells 10 in adjacent columns in the row direction Z2, the battery cell 10 in a column may be located relatively biased toward a front position (or a rear position) in the column direction Z1 such that the battery cell 10 in the column is inserted into a trough between the battery cells 10 in another column. The battery cell 10 in another column may be located relatively biased toward a rear position (or a front position) in the column direction Z1. As described above, the battery cells 10 in columns adjacent to each other in the row direction Z2 may be alternately arranged with each other relatively at front and rear positions, and, thus, the battery cells 10 in columns adjacent to each other may be arranged in a high density in a relatively small area. Therefore, the battery pack that is advantageous for compactness may be provided by a relatively dense array of the battery cells 10.

In embodiments of the present disclosure, the plurality of battery cells 10 forming the battery pack may be arranged in both the column direction Z1 and the row direction Z2 that cross each other. The columns of the battery cells 10 may include a group of the battery cells 10 arranged in the column direction Z1, and the rows of the battery cells 10 may include a group of the battery cells 10 arranged in the row direction Z2. Throughout this specification, the column direction Z1 and the row direction Z2 may correspond to directions that extend linearly to cross each other. A group of the battery cells 10 in the column direction Z1 may be arranged in the column direction Z1 from a front position to a rear position, and a group of the battery cells 10 in the row direction Z2 may be arranged in the row direction Z2 from a right position to a left position. In embodiments of the present disclosure, the group of battery cells 10 (a first group G1 of battery cells) arranged in the row direction Z2 may include battery cells 10 in columns alternately arranged in the row direction Z2, rather than including all columns of battery cells 10 arranged in the row direction Z2. For example, a group of battery cells 10 (a first group G1 of battery cells) arranged in the row direction Z2 may include battery cells 10 in odd-numbered columns, such as the battery cells 10 in a first column R1 and the battery cells 10 in a third column R3, and another group of battery cells 10 (a second group G2 of battery cells) arranged in the row direction Z2 may include battery cells 10 in even-numbered columns, such as the battery cells 10 in a second column R2 and the battery cells 10 in a fourth column R4.

In embodiments of the present disclosure, the bus bar B may extend between a group of the battery cells 10 (the first group G1 of battery cells) arranged in the row direction Z2 and another group of the battery cells 10 (the second group G2 of battery cells) arranged in the row direction Z2. The bus bar B may extend in a zigzag direction, rather than linearly extending in a direction between the first group G1 of battery cells and the second group G2 of battery cells adjacent thereto. For example, the bus bar B may extend between a group of the battery cells 10 (the first group G1 of battery cells) and another group of the battery cells 10 (the second group G2 of battery cells) adjacent to each other in the column direction Z1. The bus bar B may extend generally in a zigzag direction, while (curved sections BC of the bus bar B) around or surrounding the outer circumferential surfaces of groups of battery cells 10 adjacent to each other in the column direction Z1, for example, while alternately surrounding outer circumferential surfaces (an outer circumferential surface 10F at a front position and an outer circumferential surface 10R at a rear position) formed on facing sides of the first group G1 of battery cells and the second group G2 of battery cells adjacent thereto. The curved sections BC surrounding the outer circumferential surfaces of the battery cells 10 may be formed in the longitudinal direction of the bus bar B. Throughout this specification, the fact that the bus bar B surrounds the outer circumferential surfaces of the battery cells 10 may include the bus bar B extending across the outer circumferential surfaces of the battery cells 10 and surrounding the outer circumferential surfaces of first electrodes E1 formed at the central positions of the battery cells 10, as well as the bus bar B surrounding the outer circumferential surface of the battery cells 10. For example, in various embodiments of the present disclosure, the curved sections BC of the bus bar B may surround the outer circumferential surfaces of the battery cells 10 or surround the outer circumferential surfaces of the first electrodes E1 formed at the central positions the battery cells 10. In embodiments of the present disclosure, the curved sections BC of the bus bar B may surround the outer circumferential surfaces of the first electrodes E1 formed at the central positions of the battery cells 10. Also, the curved sections BC of the bus bar B may surround the outer circumferential surfaces of the first electrodes E1 while extending across second electrodes E2 formed at peripheral positions of the battery cells 10 around (e.g., to surround) the first electrodes E1.

In embodiments of the present disclosure, the bus bar B may generally extend in the row direction Z2, but may extend in a zigzag direction rather than extending linearly in the row direction Z2. Also, a plurality of protrusion members P may be spaced apart from each other along the length of the bus bar B. For example, in embodiments of the present disclosure, the bus bar assembly 100 may include a plurality of protrusion members P arranged at intervals along the length of the bus bar B. In embodiments of the present disclosure, the protrusion members P may be formed at approximately periodic intervals along the length of the bus bar B while each of the protrusion members P is formed on a portion (the curved section BC of the bus bar B) of the bus bar B surrounding the outer circumferential surface of the battery cell 10. In embodiments of the present disclosure, the protrusion members P may be provided in pairs formed at positions facing each other, with a first electrode E1 of one battery cell 10 therebetween, on the curved sections BC of the bus bars B that surrounds the first electrode E1 of the battery cell 10 along the lengths of the bus bars B. As described above, in embodiments of the present disclosure, the protrusion member P may be provided in plural that are formed on the curved sections BC of the bus bars B with constant (constant or substantially constant) intervals therebetween along the lengths of the bus bars B.

Each of the bus bars B may include a first surface facing the cell holder H and a second surface opposite the cell holder H, and the bus bar B may include a first protrusion P1 that protrudes from at least the first surface toward the cell holder H. In embodiments of the present disclosure, the protrusions P1 and P2 may include the first and second protrusions P1 and P2 that respectively protrude from the first and second surfaces opposite to each other of the bus bar B. However, in various embodiments of the present disclosure, the protrusions P1 and P2 may include the first protrusion P1 protruding from the first surface of the bus bar B toward the cell holder H, but may not include the second protrusion P2 protruding from the second surface of the bus bar B toward the opposite side of the cell holder H. As described below, the protrusions P1 and P2 may represent a first side and a second side, which protrude from the first and second surfaces of the bus bar B, respectively, in each of protrusion members P that are spaced apart from each other along the length of the bus bar B. In an embodiment, as described below, during insert injection molding of the cell holder H integrally formed with the bus bars B, the protrusions P1 and P2 may function as fixing protrusions for fixing the positions of the bus bars B inside a die (not shown) for forming the cell holder H. In embodiments of the present disclosure, for the purpose of firmly fixing the positions of the bus bars B, it is desirable to form both the first and second protrusions P1 and P2 that respectively protrude from the first and second surfaces opposite to each other of the bus bar B, taking into consideration that an integrated cell holder H including the position-aligned bus bars B may be formed through insert injection molding.

The formation of the battery pack according to one or more embodiments of the present disclosure may include primary insert injection molding for forming the bus bar assembly 100 itself and secondary insert injection molding for forming the cell holder H integrated with the bus bars B after the primary insert injection molding. Herein, the secondary insert injection molding is described, in which a bus bar-integrated cell holder is formed using the bus bar assembly 100 formed through the primary insert injection molding.

In an embodiment, during the secondary insert injection molding for forming the cell holder H, a high-temperature molten resin is injected into a die (not shown) in which the bus bars B are fixed, and, thus, the bus bars B and the cell holder H may be integrally molded. During this insert injection molding, the first and second protrusions P1 and P2 may provide fixing positions (corresponding to the first and second protrusions P1 and P2) for fixing the bus bars B. For example, during the insert injection molding, fixing jigs IG1 and IG2 may be in contact with the fixing positions of the bus bars B (corresponding to the first and second protrusions P1 and P2) with a certain pressure and may firmly fix the positions of the bus bars B inside the die (not shown). Therefore, despite the flow of molten resin injected into the die (not shown), the positions of the bus bars B may be firmly fixed inside the die (not shown) without movement. Also, by fixing the positions of the bus bars B, the bus bars B may be appropriately placed at positions (e.g., predetermined or designed positions) on the cell holder H that is formed from the molten resin by cooling of the molten resin injected into the die (not shown) and then separating the die (not shown).

In embodiments of the present disclosure, the first and second protrusions P1 and P2 of the bus bar assembly 100 may respectively protrude from different first and second surfaces of the bus bar B. The fixing jigs IG1 and IG2 may enter the inside of the die (not shown) from the outside of the die (not shown) and may come into contact with and press the fixing positions (corresponding to the first and second protrusions P1 and P2) of the bus bars B arranged inside the die (not shown), and, thus, the positions of the bus bars B may be fixed inside the die (not shown). For example, the fixing jigs IG1 and IG2 may be formed in an elongated shape that extends lengthwise in a direction (corresponding to the protrusion direction of the first and second protrusions P1 and P2 or corresponding to the height direction Z3) such that the fixing jigs IG1 and IG2 fix the positions of the bus bars B arranged inside the die (not shown) and having the first and second protrusions P1 and P2 while coming into contact with and pressing the first and second protrusions P1 and P2 of the bus bars B from the outside of the die (not shown). For example, in embodiments of the present disclosure, the cell holder H integrated with the bus bars B may be formed as an injection molded product of different materials that includes the bus bars B including metal and the cell holder H including a resin.

In embodiments of the present disclosure, the first and second protrusions P1 and P2 may be formed to a certain depth and a certain height from the first and second surfaces of the bus bar B, respectively. The certain depth of the first protrusion P1 and the certain height of the second protrusion P2 may be measured from the first and second surfaces of the bus bar B, respectively. In one or more embodiments of the present disclosure, the certain depth and the certain height of the first and second protrusions P1 and P2 may be designed to have the same (same or substantially same) value, but the directions thereof may be opposite to each other. For example, the first and second protrusions P1 and P2 protruding respectively from the first and second surfaces of the bus bar B may be formed from each of the protrusion members P on the curved sections BC formed at approximately periodic intervals along the length of the bus bar B. The protrusion members P may be coupled to the bus bar B such that the certain depth and the certain height protruding respectively from the first and second surfaces of the protrusion member P have substantially the same value. In one or more embodiments of the present disclosure, the protrusion member P may be formed as an elongated member that extends long enough to pass through an opening formed in the bus bar B, for example, an opening formed in the curved section BC of the bus bar B. For example, the protrusion member P may be provided as an elongated member that extends in a direction perpendicular to the first and second surfaces of the bus bar B.

Herein, in forming the battery pack, the primary insert injection molding for forming the bus bar assembly 100 itself is described. During the primary insert injection molding, the bus bar assembly 100 including a plurality of protrusion members P formed along the length of the bus bar B may be formed into a single body. For example, the bus bar B may be fixed inside the die (not shown), and the molten resin injected into the die (not shown) may fill the inside of the openings of the bus bar B and then form the certain depth and the certain height from the first and second surfaces of the bus bar B. Therefore, the bus bar assembly 100 in which the protrusion members P have certain heights at the positions of the openings may be formed into a single body. For example, the first and second protrusions P1 and P2 may include resin, such as molten resin that fills the opening of the bus bar B and forms a certain height. For example, the bus bar assembly 100 may include an injection molded product of different materials that includes the bus bar B including metal and the first and second protrusions P1 and P2 including resin. For example, in embodiments of the present disclosure, the insert injection molding for forming the bus bar assembly 100 itself in which the bus bar B and the first and second protrusions P1 and P2 are integrally formed with each other may be referred to as the primary insert injection molding. Also, the insert injection molding for forming the cell holder H, which is integrated with the bus bar assembly 100, using the bus bar assembly 100 formed through the primary insert injection molding may be referred to as secondary insert injection molding. As described above, in embodiments of the present disclosure, the cell holder H integrated with the bus bar B may be formed through the primary and secondary insert injection molding processes different from each other, and the bus bar assembly 100 may be integrally formed in the cell holder H formed through the primary and secondary insert injection molding. In embodiments of the present disclosure, the cell holder H providing the assembling positions for the plurality of battery cells 10 may be integrated with the bus bars B electrically connecting the battery cell 10 which are different from each other and assembled to the cell holder H. For example, the bus bars B and the cell holder H or the bus bar assembly 100 including the bus bars B and the cell holder H may be integrated with each other by the secondary insert injection molding. Throughout this specification, the bus bars B being integrated with the cell holder H and the bus bar assembly 100 including the bus bars B being integrated with the cell holder H may represent substantially the same configuration. In embodiments of the present disclosure, the bus bar assembly 100 may include the bus bars B and further include the protrusions P1 and P2 for fixing the positions of the bus bars B during the secondary insert injection molding. Therefore, throughout this specification, the bus bars B being integrated with the cell holder H and the bus bar assembly 100 being integrated with the cell holder H may represent substantially the same configuration.

In embodiments of the present disclosure, the bus bar assembly 100 including the bus bars B may be integrally formed through the primary insert injection molding. Also, the bus bar assembly 100 formed through the primary insert injection molding and the cell holder H may be integrated with each other through the secondary insert injection molding. For example, the bus bar assembly 100 may include an injection molded product of different materials that includes the bus bars B including a metal material and the protrusions P1 and P2 including a resin material. The cell holder H integrated with the bus bars B may include an injection molded product of different materials that includes the bus bars B including a metal material and the cell holder H including a resin material. For example, the resin (mold resin) forming the protrusions P1 and P2 and the resin (mold resin) forming the cell holder H may include a same resin (mold resin) or different types of resin (mold resin). In embodiments of the present disclosure, the mold resin forming the protrusions P1 and P2 and the mold resin forming the cell holder H may include similar mold resins having high affinity with each other. In embodiments of the present disclosure, the protrusions P1 and P2 and the cell holder H may provide an extended cell holder H formed integrally with each other while being in contact with each other. The protrusions P1 and P2 and the cell holder H being in contact with each other may be formed using a same or similar mold resin, and thus, the protrusions P1 and P2 and the cell holder H surrounding the protrusions P1 and P2 may form a strong bond therebetween. For example, the bus bar assembly 100 formed through the primary insert injection molding may be placed inside a die (not shown) for the secondary insert injection molding, and the molten resin for forming the cell holder H may be injected into the die (not shown). The molten resin for forming the cell holder H may form an interface on the basis of the high affinity with the protrusions P1 and P2, and, thus, it is possible to suppress occurrence of defects, such as separation at the interface between the protrusions P1 and P2 and the cell holder H.

In embodiments of the present disclosure, for the electrical connection between the bus bars B and the battery cells 10, the bus bar B may extend between a group of the battery cells 10 (the first group G1 of battery cells) arranged in the row direction Z2 and another group of the battery cells 10 (the second group G2 of battery cells) arranged in the row direction Z2. Between the groups of battery cells 10 (the first and second groups G1 and G2 of battery cells) adjacent to each other in the column direction Z1, the bus bar B may extend in a zigzag pattern generally in the row direction Z2 while surrounding the outer circumferential surfaces (the curved sections BC of bus bar B) of the groups of battery cells 10 (the first and second groups G1 and G2 of battery cells) adjacent to each other. For example, the bus bar B may extend in a zigzag pattern while surrounding the outer circumferential surfaces (outer circumferential surfaces 10F and 10R at front and rear positions, respectively), on the facing sides, of the battery cells 10 adjacent to each other (the first and second groups G1 and G2 of battery cells).

In embodiments of the present disclosure, the bus bar B may be electrically connected to the battery cell 10 via a conductive member (not shown) located between the first and second electrodes E1 and E2 of the battery cell 10. For example, in embodiments of the present disclosure, the bus bar B may be electrically connected to the first electrode E1 of the battery cell 10 via a conductive member (not shown) that extends between the first electrode E1 of the battery cell 10 and the bus bar B. The bus bar B may be electrically connected to the second electrode E2 of the battery cell 10 via a conductive member (not shown) that extends between the second electrode E2 of the battery cell 10 and the bus bar B. In embodiments of the present disclosure, the bus bar B electrically connecting the different battery cells 10 to each other may not necessarily represent that the bus bar B directly connects the first and second electrodes E1 and E2 of the different battery cells 10 to each other, but may represent that the bus bar B connects the first and second electrodes E1 and E2 of the different battery cells 10 to each other via the conductive member (not shown). For example, if the bus bar B connects different battery cells 10 to each other in parallel, the bus bar B may connect the same polarities of different battery cells 10 to each other via the conductive member (not shown). For example, the bus bar B may connect the first electrodes E1 or the second electrodes E2 of the different battery cells 10 to each other. Similarly, the bus bar B connecting different battery cells 10 in series may represent that the bus bar B connects the first and second electrodes E1 and E2 of the different battery cells 10 to each other via a conductive member (not shown).

In one or more embodiments of the present disclosure, the conductive member (not shown) may include a conductive wire electrically connecting the bus bar B and the battery cell 10 to each other, and the conductive wire may be connected to the bus bar B at a first end thereof and connected to the battery cell 10 at a second end thereof. Throughout this specification, the bus bar B and the battery cell 10 being electrically connected to each other may mean that the bus bar B and the first and second electrodes E1 and E2 of the battery cell 10 are electrically connected to each other. In one or more embodiments of the present disclosure, the first and second electrodes E1 and E2 of the battery cell 10 may include the first electrode E1 formed at a central position of the battery cell 10 and the second electrode E2 formed at a peripheral position around (e.g., surrounding) the central position of the battery cell 10.

In embodiments of the present disclosure, both the first and second electrodes E1 and E2 of the battery cell 10 electrically connected to the bus bar B may be formed on a first end of the battery cell 10 adjacent to the bus bar B. Also, the second electrode E2 (e.g., only the second electrode E2) may be formed on a second end of the battery cell 10 opposite the bus bar B. For example, the first and second electrodes E1 and E2 formed on the first end of the battery cell 10 may be exposed from the cell holder H via first and second electrode holes EH1 and EH2 of the cell holder H, on which the bus bar B is located, and may be electrically connected to the bus bar B. In further detail, in embodiments of the present disclosure, the battery cell 10 may have the first and second electrodes E1 and E2 formed at two ends thereof in the height direction Z3. For example, the battery cell 10 may be provided as a cylindrical battery cell 10 having a side surface in the form of a circumferential surface that connects the electrodes E1 and E2 at the first and second ends to each other. Both the first and second electrodes E1 and E2 may be formed at the first end among the first and second ends of the battery cell 10, and one electrode (the second electrode E2) among the first and second electrodes E1 and E2 may be formed at the second end of the battery cell 10. Also, the battery cell 10 may be assembled to the cell holder H such that the first end of the battery cell 10, at which both the first and second electrodes E1 and E2 are formed, faces the first side of the cell holder H on which the bus bar B is located, for example, faces the upper surface side of the cell holder H. For example, the battery cell 10 and the cell holder H may be assembled to each other such that the first end of the battery cell 10, at which both the first and second electrodes E1 and E2 of the battery cell 10 are formed, faces the first side of the cell holder H on which the bus bar B is placed (faces the upper surface side of the cell holder H).

The bus bar B may extend between the first group G1 of battery cells 10 arranged in the row direction Z2 and the second group G2 of battery cells 10 arranged in the row direction Z2. The bus bar B may extend between the first and second groups G1 and G2 of battery cells 10 adjacent to each other in the column direction Z1 and may extend while surrounding the outer circumferential surfaces of the first group G1 of battery cells 10 and the outer circumferential surfaces of the second group G2 of battery cells 10. For example, in embodiments of the present disclosure, the bus bar B may extend in a zigzag pattern while surrounding the outer circumferential surfaces of the first group G1 of battery cells 10 and the outer circumferential surfaces of the second group G2 of battery cells 10. In each of the bus bars B, the outer circumferential surfaces of the first group G1 of battery cells 10 and the outer circumferential surfaces of the second group G2 of battery cells 10, which are surrounded by a first bus bar B of the bus bars B, may be at positions opposite to each other. For example, the outer circumferential surface of each of the first group G1 of battery cells 10, which is surrounded by the first bus bar B, may refer to an outer circumferential surface 10R at a rear position in the column direction Z1, and the outer circumferential surface of each of the second group G2 of battery cells 10, which is surrounded by the first bus bar B, may represent an outer circumferential surface 10F at a front position in the column direction Z1. As described above, the first bus bar B surrounding opposite outer circumferential surfaces of the first and second groups G1 and G2 of battery cells 10 may represent that the first bus bar B surrounds the outer circumferential surface 10F or 10R at one of the front and rear positions among the outer circumferential surfaces of the first group G1 of battery cells 10, and the first bus bar B surrounds the outer circumferential surface 10F or 10R at a position of the front and rear positions among the outer circumferential surfaces of the second group G2 of battery cells 10. Also, the first bus bar B surrounding the outer circumferential surfaces, on the sides facing each other, among the outer circumferential surfaces of the first and second groups G1 and G2 of battery cells 10, may represent that the first bus bar B surrounds the outer circumferential surfaces facing each other among the outer circumferential surfaces of the first and second groups G1 and G2 of battery cells 10. For example, the above description may represent that the first bus bar B surrounds the outer circumferential surface 10F or 10R of any of the front and rear positions of the first group G1 of battery cells 10, and the one bus bar B surrounds the outer circumferential surface 10F or 10R of any of the front and rear positions of the second group G2 of battery cells 10. As described above, in embodiments of the present disclosure, the bus bar B surrounding the outer circumferential surfaces of the first and second groups G1 and G2 of battery cells adjacent to each other in the column direction Z1 may represent that the bus bar B surrounds the outer circumferential surface 10F or 10R at a position among the opposite rear and front positions or the opposite front and rear positions of each of the first and second groups G1 and G2 of battery cells 10 or the bus bar B surrounds the outer circumferential surface 10F or 10R at a position among the facing rear and front positions or the facing front and rear positions of each of the first and second groups G1 and G2 of battery cells 10.

In embodiments of the present disclosure, along the outer circumferential surfaces of each of the battery cells 10, the outer circumferential surfaces opposite to each other or the outer circumferential surfaces facing each other of one battery cell 10 may be surrounded by different bus bars B. For example, along the outer circumferential surfaces of one battery cell 10, the outer circumferential surface 10F at the front position and the outer circumferential surface 10R at the rear position may be surrounded by bus bars B different from each other or bus bars B adjacent to each other in the column direction Z1. Also, the protrusion members P may be formed on the curved sections BC of each of the bus bars B that surround the outer circumferential surfaces opposite to each other or the outer circumferential surfaces facing each other of the one battery cell 10. For example, a pair of protrusion members P may be arranged at positions facing each other with one battery cell 10 therebetween. The pair of protrusion members P may face each other with one battery cell 10 therebetween in the column direction Z1. In further detail, the pair of protrusion members P may face each other with the first electrode E1 of the one battery cell 10 therebetween.

In embodiments of the present disclosure, the curved section BC of the bus bar B may surround the outer circumferential surface of the battery cell 10 or the outer circumferential surface of the first electrode E1 formed at the central position of the battery cell 10. The protrusion member P may be provided in pairs at opposite positions or facing positions of the battery cell 10 or the first electrode E1 formed at the central position of the battery cell 10 (for example, a curved section BCF at the front position and a curved section BCR at the rear position which are opposite to each other). In embodiments of the present disclosure, the protrusion member P may be formed on the curved section BC of the bus bar B that extends across the second electrode E2 around (e.g., surrounding) the first electrode E1 with the first electrode E1 therebetween. In embodiments of the present disclosure, the protrusion members P may be formed at positions facing each other around a first electrode hole EH1 of the cell holder H that exposes the first electrode E1, and the protrusion members P may be formed at positions facing each other on the curved sections BC of the bus bars B that are formed around the first electrode hole EH1. In one or more embodiments of the present disclosure, the protrusion members P may pass through the cell holder H over the entire thickness of the cell holder H, and the protrusion members P may pass through portions around the first electrode hole EH1 of the cell holder H that exposes the first electrode E1 of the battery cell 10.

In embodiments of the present disclosure, the positions of the protrusions P1 and P2 are described below in further detail. The bus bars B may be arranged on the cell holder H. For example, the cell holder H may have a first side on which the battery cells 10 are arranged and a second side on which the bus bar assembly 100 is arranged. Assembling ribs RH for regulating the assembling positions of the battery cells 10 may be formed on the first side of the cell holder H. Each of the assembling ribs RH may surround the outer circumferential surface of the battery cell 10, and first and second electrode holes EH1 and EH2, through which the first and second electrodes E1 and E2 of the battery cell 10 are exposed, may be provided inside each of the assembling ribs RH. Also, the protrusion members P may be formed between the electrode holes EH1 and EH2 and the assembling rib RH. For example, the electrode holes EH1 and EH2 may include first and second electrode holes EH1 and EH2 through which the first and second electrodes E1 and E2 of the battery cell 10 are exposed, respectively. For example, the electrode holes EH1 and EH2 may include the first electrode hole EH1 formed at a central position of the battery cell 10 and the second electrode hole EH2 formed at an edge position of the battery cell 10. Both the first and second electrode holes EH1 and EH2 may be formed inside the assembling rib RH. In embodiments of the present disclosure, the protrusion member P may be formed between the first electrode hole EH1 and the assembling rib RH. For example, the second electrode hole EH2 may be formed together with the protrusion member P between the first electrode hole EH1 and the assembling rib RH. The protrusion members P and the second electrode hole EH2 may be formed together at different angular positions along the outer circumference of the first electrode hole EH1, for example, at first to third angular positions A1, A2, and A3 different from each other. For example, the pair of protrusion members P may be formed at opposite or facing positions (at the first and second angular positions A1 and A2) along the outer circumference of the first electrode hole EH1, and the second electrode hole EH2 may be formed between the pair of protrusion members P (at the third angular position A3) along the outer circumference of the first electrode hole EH1. In one or more embodiments of the present disclosure, the second electrode hole EH2 may be formed between the pair of protrusion members P and at the angular position (the third angular position A3) that equally divides between the pair of protrusion members P along the outer circumference of the first electrode hole EH1. For example, in one or more embodiments of the present disclosure, the protrusion member P, or the protrusions P1 and P2, may be formed at the first and second angular positions A1 and A2, respectively, facing each other with the first electrode hole EH1 therebetween, and the second electrode hole EH2 may be formed at the third angular position A3 that equally divides between the first and second angular positions A1 and A2.

The battery cell 10 may include the first and second electrodes E1 and E2 having opposite polarities, the first and second electrodes E1 and E2 may be exposed to the outside of the cell holder H via the first and second electrode holes EH1 and EH2 for exposing the first and second electrodes E1 and E2 of the battery cell 10, respectively, and the first and second electrodes E1 and E2 exposed to the outside may be connected to the bus bar B by a conductive member (not shown). For example, the first and second electrode holes EH1 and EH2 may be formed at the central position and the peripheral position of the first end of the battery cell 10 so as to correspond to the positions of the first and second electrodes E1 and E2, respectively. Also, the pair of protrusion members P facing each other may be arranged around the first electrode hole EH1 that is formed at the central position of the first end of the battery cell 10, and the second electrode hole EH2 may be formed, at the angular position that equally divides between the pair of protrusion members P (e.g., at the third angular position A3 that equally divides between the first and second angular positions A1 and A2), around the first electrode hole EH1. Also, the pair of protrusion members P and the second electrode hole EH2 may be formed together between the first electrode hole EH1 and the assembling rib RH in a radial direction of the battery cell 10. For example, in embodiments of the present disclosure, the radial direction of the battery cell 10 may refer to a direction from the central position, at which the first electrode E1 is formed, to the peripheral position, at which the second electrode E2 is formed.

In the protrusion member P, the first protrusion P1 protruding from the first surface of the bus bar B toward the cell holder H may be provided in pairs arranged along a periphery of the first electrode hole EH1 to face each other around the first electrode hole EH1. Also, the first protrusion P1 may pass through a portion of the cell holder H around the first electrode hole EH1. For example, the first protrusion P1 or the protrusion member P including the first protrusion P1 may be exposed, around the first electrode hole EH1, via the lower surface of the cell holder H, in which the first electrode hole EH1 is formed, for example, via the lower surface opposite the upper surface of the cell holder H on which the bus bars B are arranged. However, in various embodiments of the present disclosure, the first protrusion P1 may be formed to a partial depth of the cell holder H rather than passing through the entire depth of the cell holder H. For example, the first protrusion P1 may be formed to the extent that the first fixing jig IG1 entering the inside of a die (not shown) from the outside of the die (not shown) may come into contact with and press the first protrusion P1 during the insert injection molding for forming the cell holder H integrated with the bus bars B. For example, the first protrusion P1 may not be exposed via the lower surface of the cell holder H, but may be covered by the lower surface of the cell holder H. In embodiments of the present disclosure, the first protrusion P1 being exposed via the lower surface of the cell holder H may represent that the first protrusion P1 is entirely exposed via the lower surface of the cell holder H or the first protrusion P1 is partially exposed via the lower surface of the cell holder H. For example, in embodiments of the present disclosure, only a portion of the first protrusion P1 may be exposed depending on the thickness of the cell holder H.

For example, to the extent that the first protrusion P1 fixes the position of the bus bar B inside the die (not shown), the end of the first protrusion P1 may be covered by the molten resin injected into the die (not shown). Therefore, the first protrusion P1 may not be exposed via the lower surface of the cell holder H, but may be covered by the lower surface of the cell holder H. For example, in embodiments of the present disclosure, the molten resin injected into the die (not shown) may permeate into pressure contacts between the first protrusion P1 and the first fixing jig IG1 and may partially or entirely cover the first protrusion P1. Also, the second protrusion P2 of the protrusion member P may protrude in a direction opposite the direction in which the first protrusion P1 protrudes and may protrude by a certain height from the second surface of the bus bar B. For example, unlike the first protrusion P1 of the protrusion member P, the second protrusion P2 of the protrusion member P may be exposed upward from the cell holder H.

In embodiments of the present disclosure, during the insert injection molding for the bus bars B and the cell holder H, the first and second fixing jigs IG1 and IG2 different from each other may come into contact with and press the first and second protrusions P1 and P2 that protrude from the first and second surfaces of the bus bar B, respectively. For example, the first fixing jig IG1 entering the inside of the die (not shown) from below the die (not shown) may come into contact with and press the first protrusion P1, and the second fixing jig IG2 entering the inside of the die (not shown) from above the die (not shown) may come into contact with and press the second protrusion P2. By using the first and second protrusions P1 and P2 formed at a same position along the length of the bus bar B but on opposite sides of the bus bar B, it is possible to firmly fix the position of the bus bar B without causing rotational movement with respect to the bus bar B and without any rotation or distortion of the bus bar B inside the die (not shown).

According to embodiments of the present disclosure, the bus bars electrically connecting the plurality of battery cells to each other may have the protrusions for providing fixing positions of the bus bars. Therefore, the cell holder integrally formed with the bus bars may be provided using the fixing jigs that come into contact with and press the protrusions, and the bus bar-integrated cell holder may be provided in which the bus bars are firmly fixed to the cell holder at appropriate positions.

It is to be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it is to be understood by those of ordinary skill in the art that various changes in form and details may be made therein without departing from the spirit and scope of the present disclosure as set forth by the following claims.

What is claimed is:

1. A battery pack comprising:
a cell holder to which a plurality of battery cells are assembled; and
a bus bar assembly comprising a bus bar electrically connecting the plurality of battery cells to each other, and a protrusion protruding from the bus bar to at least a portion of a thickness of the cell holder, wherein the plurality of battery cells is arranged on a first side of the cell holder, and the bus bar assembly is located on a second side of the cell holder opposite the first side of the cell holder.

2. The battery pack as claimed in claim 1, wherein the plurality of battery cells is arranged on the first side of the cell holder, and the protrusion protrudes from the bus bar located on the second side of the cell holder to at least a portion of the thickness of the cell holder.

3. The battery pack as claimed in claim 2, wherein the protrusion passes through the cell holder and is exposed via a lower surface of the cell holder opposite the bus bar.

4. The battery pack as claimed in claim 1, wherein the bus bar comprises a first surface facing the cell holder and a second surface opposite the cell holder, and
the protrusion comprises:
a first protrusion protruding from the first surface toward the cell holder by a depth; and
a second protrusion protruding from the second surface by a height away from the cell holder.

5. The battery pack as claimed in claim 4, wherein the depth of the first protrusion is the same as the height of the second protrusion.

6. The battery pack as claimed in claim 4, wherein the first and second protrusions are located at positions of the bus bar facing each other.

7. The battery pack as claimed in claim 4, wherein the first and second protrusions are respectively arranged on a first side and a second side, which are opposite to each other, of a protrusion member arranged at positions spaced apart from each other along a length of the bus bar.

8. The battery pack as claimed in claim 1, wherein the plurality of battery cells are configured such that
a column of battery cells are arranged in a column direction and a plurality of columns of battery cells are arranged in a row direction crossing the column direction, and
the battery cells in columns adjacent to each other in the row direction are alternately arranged with each other at front and rear positions in the column direction.

9. The battery pack as claimed in claim 8, wherein the bus bar is provided in plural to electrically connect the plurality of battery cells to each other, and
the plural bus bars are adjacent to each other in the column direction and each of the bus bars extends between a first group of battery cells arranged in the row direction and a second group of battery cells arranged in the row direction.

10. The battery pack as claimed in claim 9, wherein each of the first and second groups of battery cells comprises battery cells in odd-numbered columns and battery cells in even-numbered columns which are alternately arranged in the row direction.

11. The battery pack as claimed in claim 9, wherein each of the plurality of bus bars extends in a zigzag pattern while forming curved sections around outer circumferential surfaces of electrodes respectively formed at central positions of the first and second groups of battery cells.

12. The battery pack as claimed in claim 11, wherein the curved sections surround outer circumferential surfaces of first electrodes respectively formed at central positions of the first and second groups of battery cells or surround outer circumferential surfaces of first electrode holes respectively formed in the cell holder to expose the first electrodes.

13. The battery pack as claimed in claim 11, wherein the curved sections adjacent to each other along a length of the bus bar surround an outer circumferential surface of a first electrode at a rear position and an outer circumferential surface of a first electrode at a front position, which are opposite to each other in the column direction, among the outer circumferential surfaces of the first electrodes of the first and second groups of battery cells.

14. The battery pack as claimed in claim 11, wherein the protrusion is arranged in each of the curved sections of the bus bar.

15. The battery pack as claimed in claim 14, wherein the protrusion is provided in pairs formed in the curved sections that face each other and surround the electrode of each of the plurality of battery cells.

16. The battery pack as claimed in claim 1, wherein first and second electrodes arranged at a first end of each of the battery cells are exposed to an outside of the cell holder through first and second electrode holes formed in the cell holder, and the first and second electrodes are connected to the bus bar, and
the second electrode is arranged at another end of the battery cell, from among the first and second electrodes.

17. The battery pack as claimed in claim 16, wherein the first and second electrode holes are formed at a central position of the first end of the battery cell and a peripheral position thereof around the central position, respectively.

18. The battery pack as claimed in claim 16, wherein the cell holder comprises assembling ribs to surround outer circumferential surfaces of the battery cells and guide assembling positions of the battery cells, and
the second electrode hole is formed between the first electrode hole and the assembling rib in a radial direction of the battery cell from the central position to the peripheral position of the battery cell.

19. The battery pack as claimed in claim 18, wherein each of the protrusions is arranged together with the second electrode hole between the first electrode hole and the assembling rib.

20. The battery pack as claimed in claim 19, wherein the protrusion is formed at first and second angular positions that face each other with the first electrode hole therebetween, and
the second electrode hole is formed at a third angular position that equally divides an angle between the first and second angular positions.
